(19) United States
(12) Patent Application Publication
(10) Pub. No.: US 2023/0196294 A1
(43) Pub. Date: Jun. 22, 2023

(54) AUTOMATIC EMPLOYMENT VERIFICATION USING LINKED DATA STRUCTURE

(71) Applicant: CrossChq, Inc., Danville, CA (US)

(72) Inventors: Pete Goettner, San Francisco, CA (US); Mike Fitzsimmons, Diablo, CA (US)

(73) Assignee: CrossChq, Inc., Danville, CA (US)

(21) Appl. No.: 17/937,988

(22) Filed: Oct. 4, 2022

Related U.S. Application Data
(60) Provisional application No. 63/253,413, filed on Oct. 7, 2021.

(51) Int. Cl. G06Q 10/1053; G06Q 50/00

(52) U.S. Cl. CPC G06Q 10/1053; G06Q 50/01

(57) ABSTRACT

In some embodiments, a method receives a request for employment verification of a company for a user and reviews a data structure for a node associated with the user. A number of references that are needed for the user for verification of the company is determined based on reviewing the data structure. The method receives information from the number of references for the verification of the company and generates a first connection between the node associated with the user and a node for the company, and a number of second connections between nodes for the number of references and the node associated with the user. A score for the verification is determined based on scores for nodes that are determined based on the first connection and the number of second connections. The method determines a decision on the verification of the company based on the score.

### CROSS REFERENCE TO RELATED APPLICATIONS

Pursuant to 35 U.S.C. § 119(e), this application is entitled to and claims the benefit of the filing date of U.S. Provisional App. No. 62/253,413 filed Oct. 7, 2021, the content of which is incorporated herein by reference in its entirety for all purposes.

### BACKGROUND

Obtaining employment verifications may be a highly manual process. For example, a user may apply to a company that requires the user's employment history be verified before the user can receive a job offer. In some cases, a user may have a large number of companies that need to be verified. The company may have to manually verify each company, which may require a phone call to each company. Or, in some cases, the company may hire a third party to manually verify each company. The above manual verifications may take a long time and use multiple resources of the company.

### BRIEF DESCRIPTION OF THE DRAWINGS

With respect to the discussion to follow and to the drawings, it is stressed that the particulars shown represent examples for purposes of illustrative discussion, and are presented to provide a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a simplified system for performing reference and employment verification according to some embodiments.

FIG. 2 depicts a first instance of a graph database according to some embodiments.

FIG. 3 depicts an example of the graph database after a user receives an employment verification request and provides two co-worker references according to some embodiments.

FIG. 4 depicts an example of the graph database after receiving responses from references that create a user-company connection according to some embodiments.

FIG. 5 depicts an example of the graph database when propagating confidence levels to a user's references according to some embodiments.

FIG. 6 depicts an example of propagating the confidence scores to update other nodes in other layers according to some embodiments.

FIG. 7 depicts a simplified flowchart for verifying a candidate according to some embodiments.

FIG. 8 depicts a method for propagating changes in the graph database according to some embodiments.

FIG. 9 depicts a simplified flowchart of a method for generating confidence scores according to some embodiments.

FIG. 10 depicts a more detailed example of a verification system according to some embodiments.

FIG. 11 illustrates an example of special purpose computer systems according to some embodiment.

### DETAILED DESCRIPTION

Described herein are techniques for a database system. In the following description, for purposes of explanation, numerous examples and specific details are set forth to provide a thorough understanding of some embodiments. Some embodiments as defined by the claims may include some or all the features in these examples alone or in combination with other features described below and may further include modifications and equivalents of the features and concepts described herein.

Some embodiments provide automatic verification for users, such as automatic verifications of employment from references. A reference may be an entity that can verify employment of a candidate, such as any user (e.g., co-workers of the user at a company), a company (e.g., a human resources department), etc. A company may require verification of employment for users, such as for job applicants, using references. The company or the user may use a system to verify the employment of the user. For example, the system may facilitate obtaining verification from references. Then, based on those reference verifications, the system may automatically verify the employment of the user.

The system may store a data structure in a database that represents relationships between nodes. Entities may be associated with the nodes, such as users and companies. The data structure may also include relationships between users and companies, or between users. In some embodiments, the data structure is an interconnected data structure, which may be referred to as a graph database. The interconnections between nodes may be based on relationships of users to other users or employers. An interconnection may represent a relationship between the entities associated with the nodes that is established during a verification process (e.g., a job verification process).

A score, such as a confidence score, may be associated with an interconnection. The confidence score represents a confidence in a user's job history between the user's node and a company node. Another score may be a confidence between a user and another user, such as when a user verifies that another user worked at Company 1. As job verifications are received, the confidence scores may be automatically updated based on the relationships in the graph database.

The system may also store employment verification information that is implicit based on explicit responses. For example, employment verification information may include explicit information indicating the user worked at a company 1 and implicit information that the reference worked at company 1. The explicit information may be stored with the user that is requesting the verification and the implicit information is stored by the reference that provided the verification. The system may then generate a confidence score that rates the confidence level of the employment verification. The confidence score may allow the system to automatically verify employment for users using the implicit information and/or explicit information.

In some examples, Jim Smith is applying for a job at Company 2. Company 2 would like to verify his employment at Company 1. Conventionally, Company 2 would call the human resources department at Company 1 to verify the employment of Jim Smith. However, the present system may leverage prior verifications from references that have been performed for Company 1 to improve the verification process. This may be different from calling Company 1 for verification. The present verification may use references that may have worked with the candidate, but are typically not official sources for Company 1, such as the human resources department. Accordingly, the present system uses the confidence scores to evaluate whether the employment should be verified because the references may not be official sources. Typically, calling the human resources department of a company is time consuming and reaching a user in the department is very hard. However, using the present system, users that may have been co-workers may be easier to reach in addition to being willing to help a candidate they know personally. In some examples, based on a confidence score meeting a threshold, the system may automatically verify the employment at Company 1 and not require any references because the system may calculate that it is highly likely Jim Smith worked at Company 1. Also, depending on the confidence score, the system may dynamically determine how many references may be required. For example, a higher confidence score may require one reference, and a lower confidence score may require three references. If references are required, once the references are contacted and the responses are received, the system may update the graph database. For example, if Jane Doe verified Jim Smith, the confidence score that Jim Smith worked at Company 1 goes up. Then, the system may recalculate the confidence scores of other users based on this, such as a confidence score of a user that worked at Company 1 may go up because that user worked with Jim Smith. This propagation of scores through the interconnections improves the accuracy of the graph database and allows future verifications to be performed faster and more accurately.

Accordingly, the automatic verification of employment may improve the employment verification process. A company may not have to manually verify employment, and this reduces the number of resources that are used and improves the speed of verification. Also, using a confidence score to verify employment may allow instant verifications, and reevaluating confidence scores of connected nodes improves the graph database.

System Overview

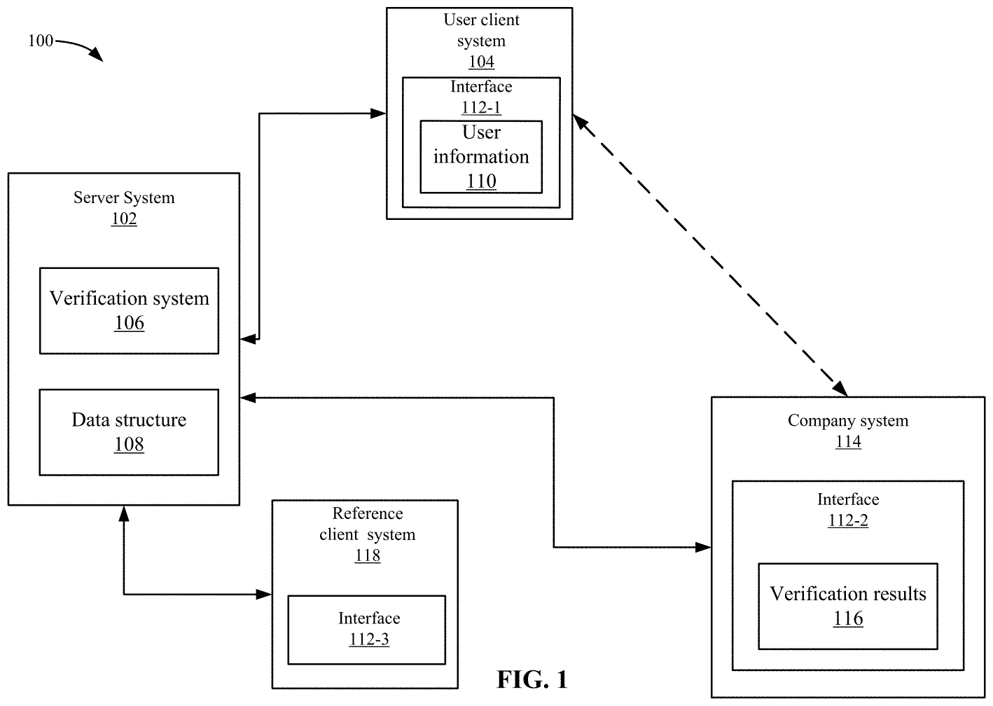

FIG. 1 depicts a simplified system 100 for performing reference verification and employment verification according to some embodiments. System 100 includes a server system 102, a user client system 104, and a company system 114. Although single instances of the entities are shown, it will be understood that multiple instances may be appreciated. Further, the instances may be implemented by multiple computing devices, which may perform functions described in a distributed manner.

Server system 102 may be associated with a verification provider that may verify information for company system 114 and/or user client system 104. Server system 102 includes a verification system 106 that can perform reference verification and employment verification of users. Server system 102 may be associated with a verification company that is separate from company system 114 and a user of user client system 104 or may be software used by company system 114.

Company system 114 may be associated with an entity, such as an employer, that wants to verify references and/or employment for a user. For example, the company may be hiring a user and wants to verify employment that a user worked at a Company 1, or verify a reference for that user.

User client system 104 may be associated with a user, such as a user that is applying for a job at a company associated with company system 114. Although applying for a job is described, the employment verification and reference verification may be performed for purposes other than applying for a job. For example, a user may be verifying employment to complete a mortgage application. Further, although employment verification is described, the processes described herein may be used for other types of verifications, such as reference verification where references are verified for a candidate.

A user may require employment verification and/or reference verification at the company associated with company system 114. The employment verification may require verification by references, which may be co-workers of the user. That is, the reference may be a person that works or has worked at a company in which the user worked. Company system 114 may then require verification of the employment. Also, a reference may verify other aspects, such as a user's character, work habits, etc., which may be referred to as a reference verification. In some examples user client system 104 may send a request to server system 102 to verify the employment. In other embodiments, company system 114 may send a request to server system 102 instead of user client system 104.

A user may provide user information 110 via an interface 112-1. User information 110 may include information for employment and/or references for the user. Verification system 106 may then verify the employment and/or references. As will be described in more detail below, verification system 106 may use information from a data structure 108 to verify the employment and/or references. Data structure 108 may be organized in a structure that links nodes for users together based on reference verifications and job verifications. In some embodiments, data structure 108 is based on a graph data structure.

To verify the employment or reference, a reference may be contacted, such as by server system 102. The reference may use a reference client system 118 to provide information for the verification via interface 112-3. For example, verification system 106 may send a communication that asks the reference to verify the user's employment at Company 2. The reference may respond with an answer, such as indicating whether the user worked at Company 2. Verification system 106 may store the information in the graph database, the process of which will be described in more detail below.

After analyzing information in data structure 108, verification system 106 may determine whether the references and/or employment are verified automatically without user input. Then, verification system 106 automatically sends verification results to company system 114 via an interface. The results can then be displayed on an interface 112-2 as verification results 116. The above process will now be described in more detail by describing the graph database, the verification process, and the updating of the graph database.

Graph Database

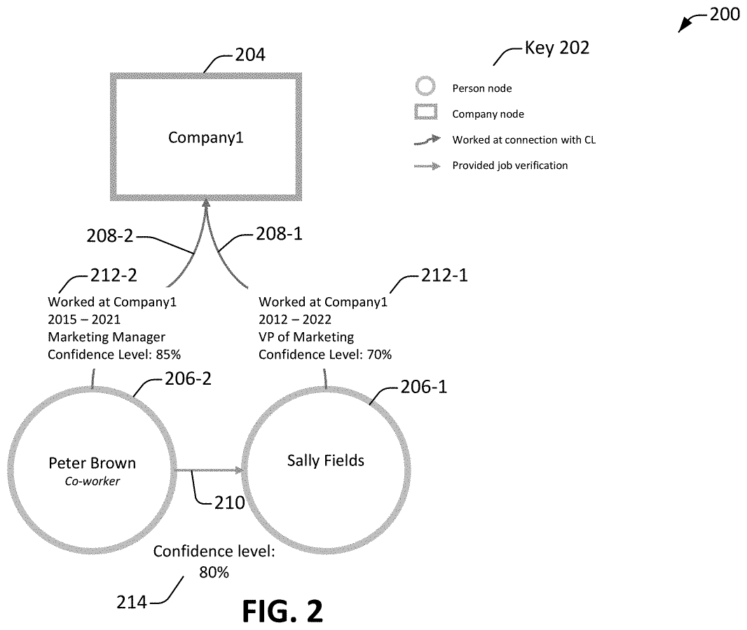

FIGS. 2-6 depict examples of a graph database according to some embodiments. FIG. 2 depicts a first instance of graph database 200 according to some embodiments. FIG. 2 shows a state of graph database 200 before a request is received for verification according to some embodiments. A key 202 describes the components of graph database 200, which may include a person node 206, a company node 204, a company connection 208, and a user connection 210. All users are stored as nodes in graph database 200 along with their job history. The user connections and the confidence score in that relationship are stored via connections between nodes. Also, the connection between users may include metadata 214. The confidence score indicates a confidence that a user verified another user. A confidence in a user's job history is stored as a connection between the user's node and the company node. The connection between a company and a user may include metadata 212 that describes the connected nodes. For example, metadata 212 may include the Company name, the years worked at the company, the job title held, and/or a confidence score. The confidence score may be a score that indicates a confidence that a user worked at the connected company and may be based on different factors, such as the number of connections in a graph, whether the reference verified employment for a company and used the official email of the company, has previously verified other candidates, etc.

In graph database 200, company node 204 is for a company named “Company 1”, which may be a company in which Peter Brown and Sally Fields may have worked. Previously, Sally Fields may have applied for a job and provided a reference of Peter Brown to verify her employment at Company 1. Peter Brown verified the employment (e.g., by saying yes or no to whether Sally Fields worked at Company 1 and verified the time of 2012-2022 and the job title of VP of Marketing). Then, verification system 106 stores information in graph database 200 to reflect the received information. For example, verification system 106 stored a job verification connection 210 between Peter Brown and Sally Fields. Also, verification system 106 stored job verification connections 208-1 and 208-2 between Sally Fields and Company 1, and Peter Brown and Company 1, respectively.

Verification system 106 also stores metadata 212-1 and 212-2. Metadata 212-1 and 212-2 stores respective information that is known about Sally Fields and Peter Brown, respectively. For example, the time that was each worked at Company 1 and the title is included in the metadata. Also, the metadata includes a confidence score that is calculated based on the information received from Peter Brown and other factors. The score value represents the confidence that either Peter Brown or Sally Fields worked at Company 1. In this example, the confidence score may be between 1-100, with a higher score indicating a higher confidence. However, other scoring methods may be appreciated. Verification system 106 uses the co-worker's response and data to calculate a confidence score for a user. Verification system 106 may combine co-worker confidence scores that are connected to a user into a single confidence score for a user. Additionally, updating a confidence score for a node may also consider confidence scores from connected nodes.

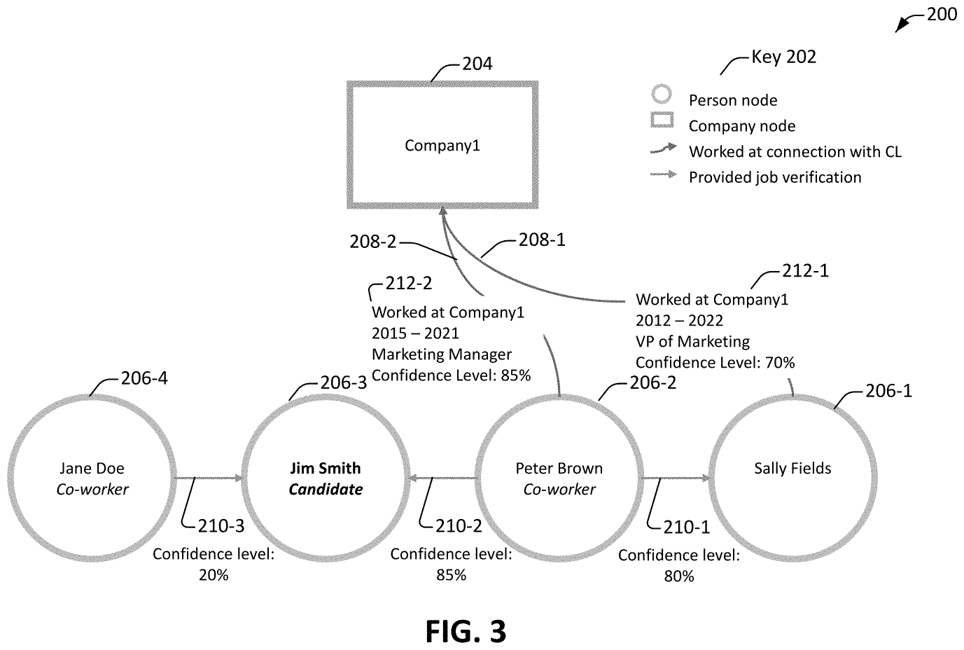

FIG. 3 depicts an example of the graph database after a user receives an employment verification request and provides two co-worker references according to some embodiments. In some examples, a company such as Company 2, requires employment history be verified on a candidate before they are hired. For example, Jim Smith is a candidate for a job at a Company 2 and reports that he worked at Company 1. To verify employment at Company 1, Jim Smith provides two co-workers of Jane Doe and Peter Brown that can verify his employment at Company 1. The process of verifying the reference will be discussed in more detail below. The following assumes that Peter Brown and Jane Doe verify that Jim Smith worked at Company 1.

Upon verification, a reference connection between Peter Brown and Jim Smith is generated at 210-2 and a user connection between Jane Doe and Jim Smith is generated at 210-3 in graph database 200. Verification system 106 also assigns a confidence score to the reference connections. For example, reference connection 210-2 is assigned a confidence score of 85% and reference connection 210-3 is assigned a confidence score of 20%. The connection between Peter Brown and Jim Smith is assigned a higher confidence score because Peter Brown is already in graph database 200 and also provided other job references, which may have been verified as being true or not disputed as being false. However, Jane Doe is not in graph database 200 and has not provided any other verifications or been verified as being employed at Company 1, which contributes to Jane Doe being assigned a lower confidence score. Verification system 106 may have less confidence to believe the verification from Jane Doe.

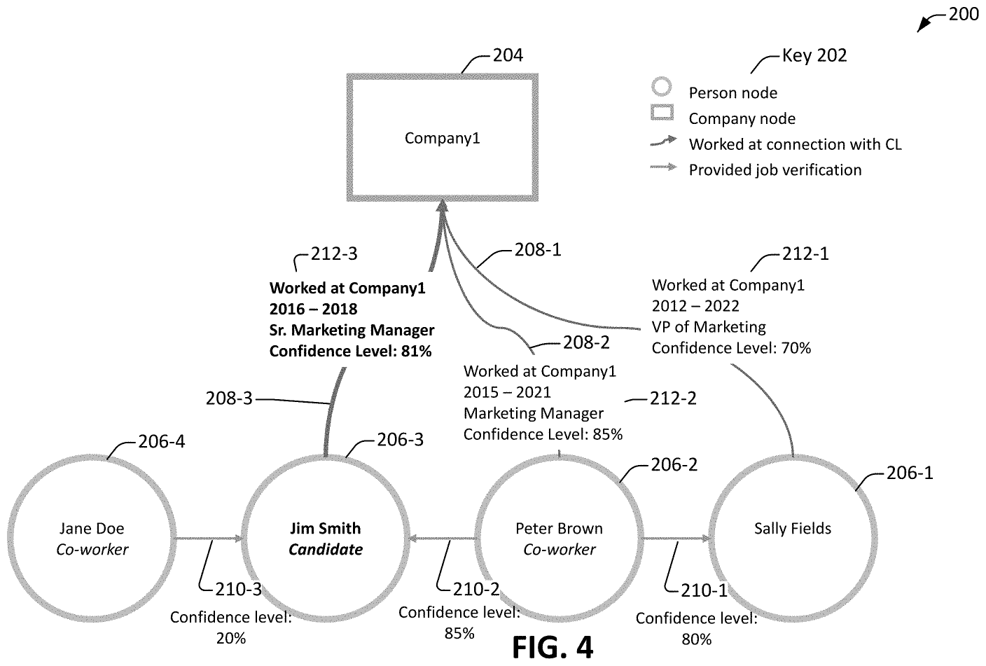

Verification system 106 may also create company connections. FIG. 4 depicts an example of the graph database after receiving responses from references that create a user-company connection according to some embodiments. For example, verification system 106 may create a company connection 208-3 between Jim Smith and Company 1 upon contacting Jane Doe and Peter Brown. Also, verification system 106 may add metadata 212-3 for the connection. This metadata may indicate information for the company connection, such as Jim Smith worked at Company 1 from a time period of 2016 to 2018 and had a title of a Senior Marketing Manager. The confidence score assigned may be 81%. Verification system 106 may calculate the confidence score based on other information in graph database 200. For example, the confidence score may be based on connections to Jim Smith, such as Jane Doe, Peter Brown, and Sally Fields. Also, the confidence score may be based on other nodes that are connected to Company 1, such as more nodes that are connected to Company 1 may result in a higher confidence score. In some examples, Peter Brown has a confidence score of 85% as having worked for Company 1 and this provides a high confidence score that Jim Smith worked at Company 1 when Peter Brown provides verification. Also, an additional verification from Jane Doe may also contribute to the confidence score, and the inclusion of Sally Fields as working at Company 1 may increase the confidence score. The confidence score may decrease in certain situations also, such as if Jane Doe indicated that Jim Smith did not work at Company 1 or if there are a small number of nodes connected to Company 1, or if verification system 106 detected fraud in a reference's response. Other nodes that may be connected to Jim Smith through multiple layers of the graph database may also affect the confidence score. For example, Sally Fields is connected to Jim Smith through Peter Brown and the confidence score that Sally Fields worked at Company 1 may also affect the confidence score for Jim Smith working at Company 1. In some embodiments, verification system 106 may analyze all the connections for Company 1 to determine the confidence score. In other embodiments, a number of layers that are analyzed may be set and used to determine the confidence score. For example, the nodes that are located five layers from Jim Smith may be analyzed to determine the confidence score that Jim Smith worked at Company 1.

Verification system 106 may also store an implicit feature for the company with a node associated with a user in graph database 200. This is an implicit feature because the reference has not requested a verification for the company (e.g., Jane Doe has not explicitly asked to have a verification that she worked at Company 1; rather, she was asked to be a reference for Jim Smith). However, it is implicit that the reference worked at company 1 because the reference verified the candidate as having worked at Company 1. For example, because Jane Doe provided a job verification for Jim Smith, verification system 106 may generate a connection between Jane Doe and Company 1.

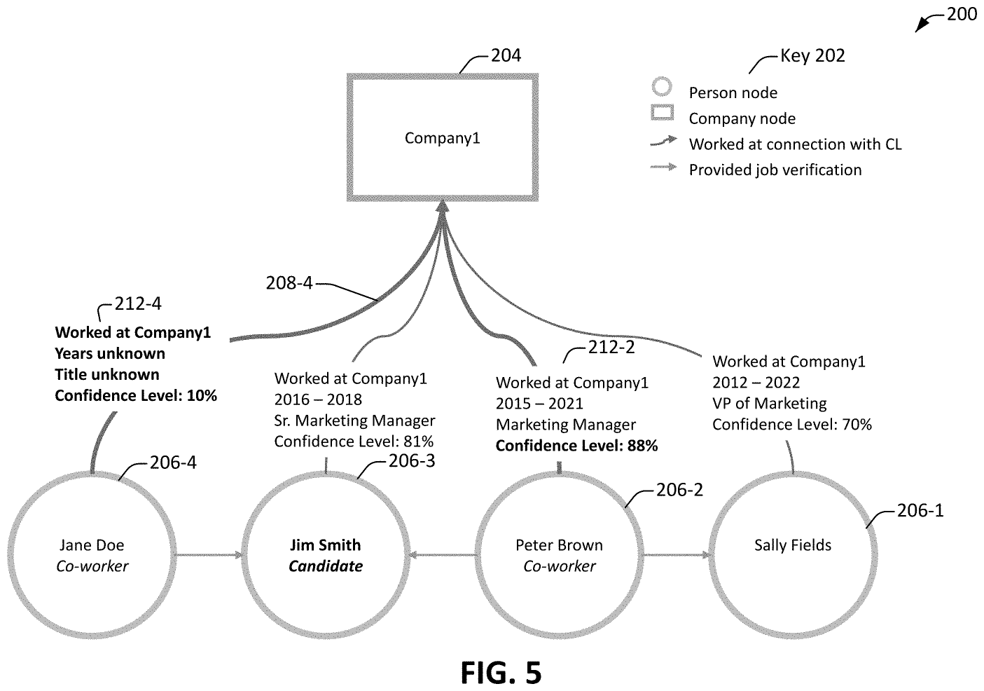

FIG. 5 depicts an example of the graph database when propagating confidence levels to a user's references according to some embodiments. When Jane Doe provides a job verification for Jim Smith, verification system 106 may generate a connection between Jane Doe and Company 1 at 208-4. For example, if Jane Doe indicates that Jim Smith worked at Company 1, verification system 106 can implicitly determine that Jane Doe worked at Company 1 and creates a company connection at 208-4. Also, even if Jane Doe indicated that Jim Smith did not work at Company 1, a connection between Jane Doe and Company 1 may be created since Jane Doe is indicating that she worked at Company 1 and can verify that Jim Smith did not work there.

Verification system 106 may also generate metadata for the connection at 212-4. For example, the metadata may be that Jane Doe worked at Company 1, but the time period and title may be unknown because that information had not been provided and/or verified. Also, verification system 106 assigns a confidence score of 10%. This confidence score is lower than the other confidence scores for the other connections because Jane Doe has not been explicitly verified as working at Company 1. Rather, an implicit connection has been created. The confidence score value may also be based on the confidence scores of nodes that are connected to Jane Doe, such as the confidence scores for Jim Smith, Peter Brown, and Sally Fields. The higher confidence scores for these nodes may create a higher confidence score for Jane Doe working at Company 1. For example, if it is known that Peter Brown and Sally Fields worked at Company 1 with high confidence and they verify Jim Smith, then Jane Doe verifying Jim Smith may create a higher confidence that Jane Doe worked at Company 1. However, the confidence score for Jane Doe is lower than if she was explicitly verified as working for Company 1.

Accordingly, users have implicit features and explicit features stored for companies in graph database 200. Each user may be associated with a node and may have associated features. The nodes may be linked based upon the verification requests that are performed. For example, the node for Jim Smith and Company 1 is linked due to an explicit request for verification. The node for Jane Doe and Company 1 is linked due to an implicit consideration that Jane Doe works at Company 1 due to her providing a verification for Jim Smith.

Verification system 106 may also use a confidence score to update other nodes after a verification. For example, Jim Smith is connected to Company 1 with a confidence score of 81%. Then, verification system 106 uses this value to adjust the confidence score for nodes connected to Jim Smith. For example, the confidence score for Peter Brown is adjusted upward to 88% from 85%. This may be because Jim Smith has also been verified by Jane Doe, which may indicate that Peter Brown is providing truthful answers and may have worked at Company 1 with higher confidence.

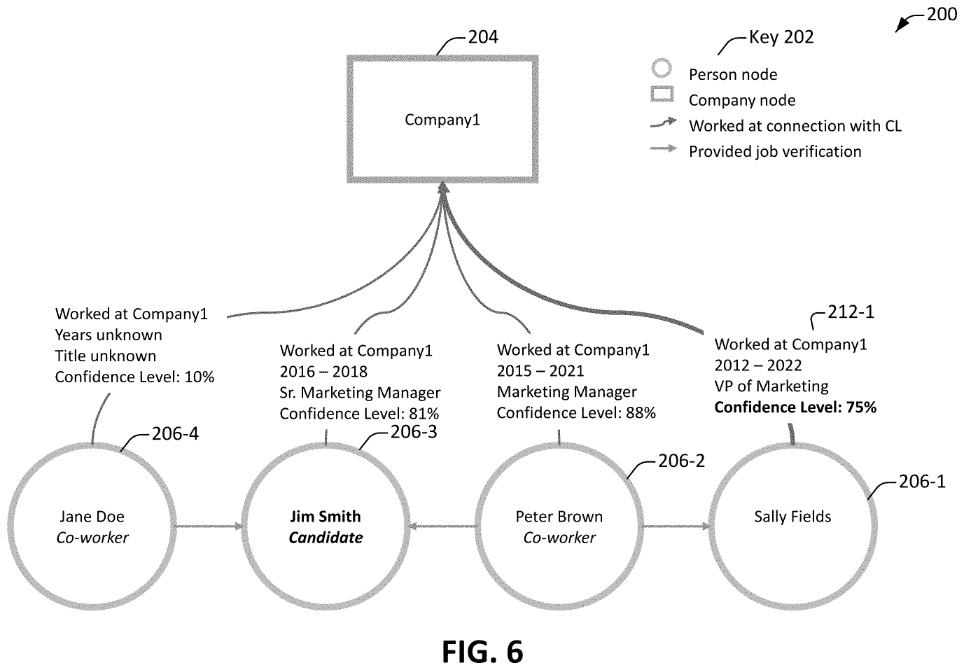

FIG. 6 depicts an example of propagating the confidence scores to update other nodes in other layers according to some embodiments. For example, the confidence score in metadata at 212-1 for Sally Fields may be updated based on the update of the confidence score for Jim Smith and/or Peter Brown. For example, the confidence score for Sally Fields is increased from 70% to 75%. The confidence score may be increased due to the confidence score for Peter Brown being increased and the addition of Jim Smith with the confidence score of 81%. Sally Field's confidence score may be increased because Peter Brown verified Sally Fields as working at Company 1 and verification system 106 has greater confidence that Peter Brown worked at Company 1, thus increasing the confidence that Sally Fields worked at Company 1. This process may be performed at multiple layers of graph database 200. In some embodiments, the confidence scores for the entire graph associated with a specific company may be recalculated. Also, the graph for a second company may have scores recalculated, such as when a user worked at a second company and that user's updated confidence score for the first company is used to update another node (e.g., the user's node or another user's node) for the second company. In other embodiments, the calculation may be stopped after a number of layers. For example, five layers of connections from a node that is added may have their confidence scores recalculated.

The above recalculation may improve graph database 200. For example, the propagation may adjust the confidence scores as new information is received for other nodes. In some embodiments, the confidence score is adjusted even when a specific node has not been verified in the current verification. That is, based on actions on other nodes, the confidence score may be adjusted on other nodes. The recalculation may increase the accuracy of the confidence scores dynamically as nodes are added and confidence scores are updated. As confidence scores are updated with additional verifications, the scores may typically increase, which in turn reduces the number of references required for each employment verification, reducing the time required by the system to verify employment.

Verification Process

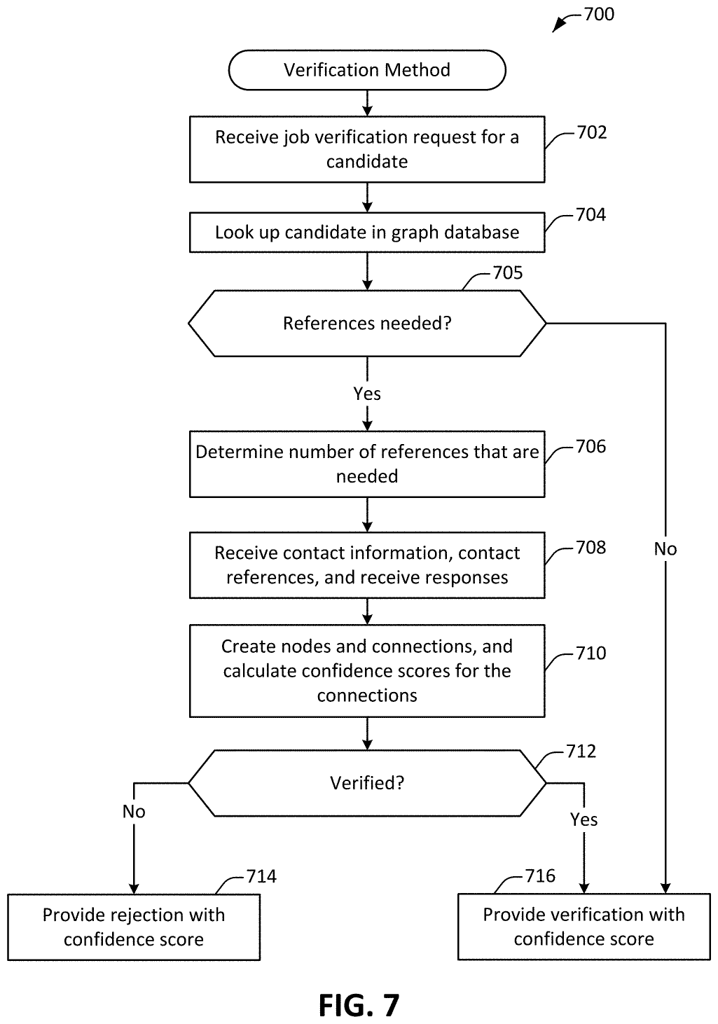

The following will now discuss the verification process in more detail. FIG. 7 depicts a simplified flowchart 700 for verifying a candidate according to some embodiments. At 702, verification system 106 receives a job verification request for a candidate. As discussed above, a candidate may apply for a job at Company 2 and list Company 1 as a prior employer. Company 2 may want to verify candidate's employment at Company 1. Company 2 may contact the provider for employment verification and/or the candidate. In some examples, a minimum confidence level needed to confirm an employment may be used. The minimum confidence level may be provided as a parameter in the employment verification request, may be preset, set dynamically based on analyzing information in the graph database, etc. Verification system 106 will use the minimum confidence level required along with information already stored in the graph database to determine the number of references needed to verify the candidate for Company 1.

At 704, verification system 106 looks up the candidate in graph database 200. For example, the candidate may have previously been verified when the candidate applied for a job at another company, such as Company 1. For example, Peter Brown is already listed in graph database 200 as shown in FIG. 2. In other examples, the candidate may have provided a reference for other users and is listed in graph database 200. This is true for Jane Doe after she provides a reference for Jim Smith in FIG. 5.

At 705, verification system 106 determines whether references are needed. As discussed above, the confidence score for a candidate may allow verification system 106 to automatically verify a candidate without requiring any references. For example, when a request for verification of a candidate is received, verification system 106 may compare the confidence score for a connection for the candidate to Company 1 to a threshold, such as the minimum confidence level that is received in the request. For example, if the confidence score is greater than the minimum confidence level, it is very likely that the candidate worked at Company 1. Then, verification system 106 may automatically verify the candidate without requiring any references. This improves the process of verifying candidates as verification may be provided to Company 2 faster allowing Company 2 to make a faster decision on the employment of the candidate. Also, the verification calculation is performed using less resources as additional references do not need to be added to graph database 200.

Accordingly, a user can have employment verified automatically based on prior reference verifications. The job may be verified based on an implicit or explicit entry for the company associated with the job. This improves the employment verification process because manual resources may not be needed to perform the job verification. Further, the job verification may leverage the reference verification process by including implicit entries for companies when reference verifications are performed.

If references are needed, at 706, verification system 106 dynamically determines the number of references that are needed to verify the candidate for Company 1. For example, if the candidate is not in graph database 200, then a larger number of references may be required. In some examples, for candidates that are not in graph database 200, a set number of references, such as four, may be required. In other examples, verification system 106 may analyze a number of factors to determine the number of references that may be needed. For example, when the candidate is found in the graph database 200, the existing confidence score for the candidate may be used to determine the number of references that are needed along with the minimum confidence level provided with the request. In some examples, the existing confidence score for the candidate may be sufficient, and no additional references are required. In general, if an existing confidence score for the candidate is lower than the minimum confidence level provided in the request, verification system 106 may adjust the process to see if the confidence score can be increased. For example, verification system 106 may determine that the candidate should provide additional references so that a confidence level above the minimum requested can be attained by having more references verify the employment.

At 708, if references are required, verification system 106 asks the candidate for information for the references, contacts the references, and receives the responses. For example, using a secure website, the candidate may enter information for co-workers that can verify that the candidate worked at Company 1 for a given period of time and with a specific title. Then, verification system 106 may contact each co-worker and ask them to verify the candidate's employment information. In some embodiments, verification system 106 may automatically contact the candidate, such as via an e-mail, text message, or automated phone call. In other embodiments, a user may use the information to contact the co-workers.

At 710, verification system 106 creates nodes and connections, and calculates confidence scores for the connections. For example, for each co-worker that is not in graph database 200, verification system 106 creates a node for that co-worker. Additionally, a node may be created for the candidate if the candidate is not already in graph database 200. Then, verification system 106 creates connections between the co-workers and the candidate. Also, verification system 106 may create a connection between the candidate and the company, and also connections between the co-workers and the company. Also, verification system 106 may generate confidence scores for the connections. For example, FIG. 3 depicted creating nodes for the candidate and a co-worker in addition to a reference connection. FIG. 4 created a company connection for the candidate along with a confidence score. FIG. 5 created a company connection for the co-worker along with a confidence score. In some examples, verification system 106 may determine that a sufficient confidence level has not been attained and additional references may be requested from the candidate at 706. In this case, the process may iterate back to 706.

At 712, verification system 106 determines if the candidate is verified. For example, verification system 106 may determine whether the confidence score for the company connection between the candidate and Company 1 meets a threshold. In some examples, if the confidence score is above a threshold, such as 70%, the candidate may be verified. In some cases, verification system 106 may compare the confidence score to a minimum confidence score provided in the employment verification request. If the candidate is not verified, then verification system 106 may provide a rejection of the verification with the confidence score. For example, a message may be sent indicating the candidate has not been verified to work at Company 1 and a confidence score of 20% is provided. This confidence score indicates that verification system 106 considers that the candidate worked at Company 1 with a confidence of only 20%.

If the candidate was verified, at 714, verification system 106 provides the verification with a confidence score. For example, verification system 106 may send a message indicating that the candidate has been verified to work at Company 1 with a confidence score. The confidence score may be higher than a threshold, such as 85%, which may indicate that verification system 106 considers it more likely that the candidate had worked at Company 1.

Score Propagation

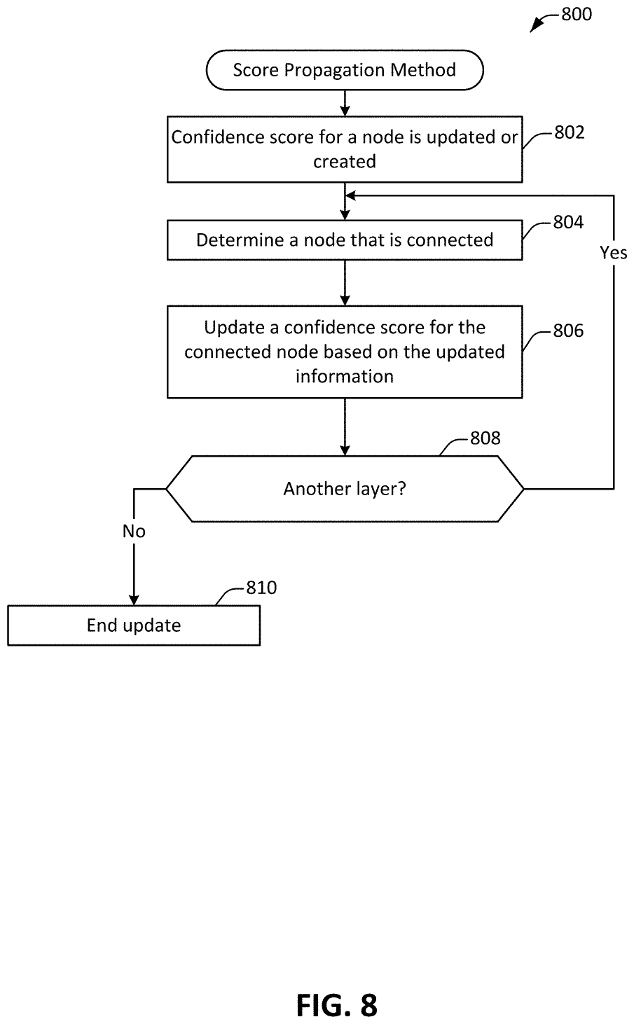

As discussed above, the confidence scores may be updated by propagating information from an updated confidence score through nodes of graph database 200. FIG. 8 depicts a method for propagating changes in graph database 200 according to some embodiments. At 802, verification system 106 updates a confidence score or creates a new confidence score. For example, in FIG. 4, a confidence score for Jim Smith is created at 81%.

At 804, verification system 106 determines a node that is connected to the node. For example, in FIG. 5, verification system 106 determines Peter Brown is connected to Jim Smith.

At 806, verification system 106 updates the confidence score for the connecting node based on updated information. For example, in FIG. 5, the confidence score that Peter Brown worked at Company 1 is increased to 88% from 85% because of the verification for Jim Smith.

At 808, verification system 106 determines if the update should be propagated to another layer. For example, the entire graph of nodes connected to the company node may be updated. However, a number of layers from the candidate may be updated, such as five layers. If there is another layer to update, the process reiterates to 804. For example, FIG. 6 depicts the updating of the confidence score of Sally Fields to 75% from 70%. Sally Fields is another layer away from Jim Smith and is connected to Jim Smith via Peter Brown. The process continues until the update should end. Then, at 810, the update is ended, such as when five layers have been reached.

Confidence Score

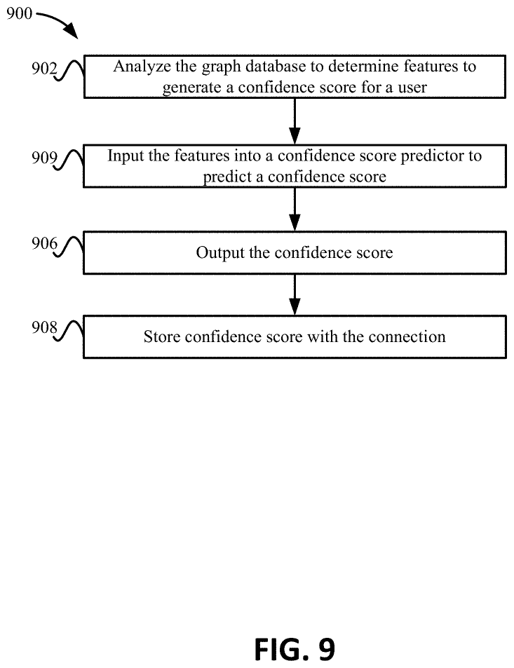

FIG. 9 depicts a simplified flowchart 900 of a method for generating confidence scores according to some embodiments. At 902, verification system 106 analyzes graph database 200 to determine features for generating a confidence score for a user. The confidence score may be generated for a connection associated with a user being verified or a connection for another user in graph database 200. The features may include the number of times a job has been verified by unique individuals, the number of requests that have been ignored or not provided, the job confidence score at the requested company of the user providing the verification, the reputation of the individual providing the verification, the security details of each verification, such as a fraud detection, the e-mail address used to request or provide the verification (e.g., a corporate e-mail address may improve the confidence score), etc.

At 904, verification system 106 inputs the features into a confidence score predictor to predict a confidence score. At 906, the confidence score predictor outputs a confidence score. For example, the confidence score predictor may analyze the features based on a model that is trained to generate a confidence score. At 908, verification system 106 stores the confidence score with the connection. Stored verifications may be used for future requests, potentially reducing the work required to obtain these verifications.

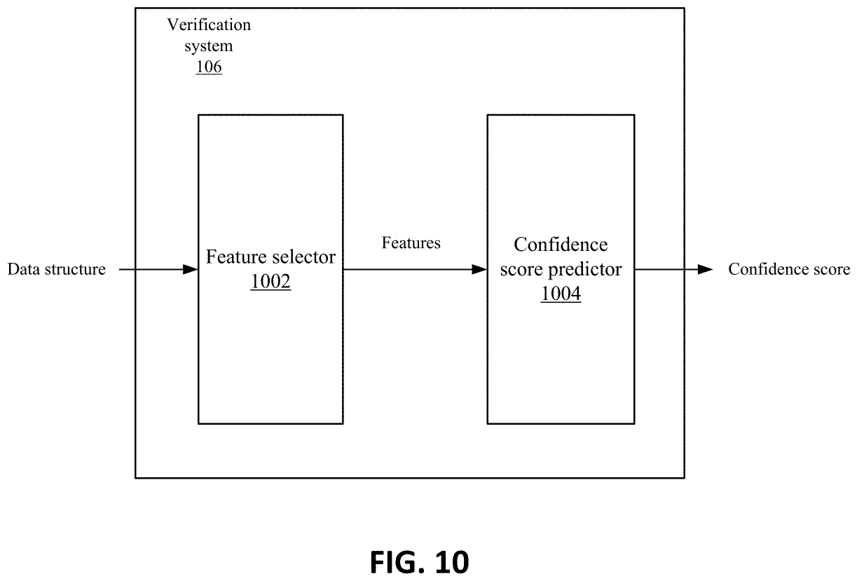

FIG. 10 depicts a more detailed example of verification system 106 according to some embodiments. A feature selector 1002 receives information from graph database 200. Feature selector 902 may analyze nodes in graph database 200 to determine features for a connection. For example, the number of connections between nodes and the confidence scores of connected user nodes may be analyzed generate a confidence score. In this way, any changes to the nodes in the data structure are automatically propagated to connected nodes. The features that are determined may be described above. A confidence score predictor 1004 may include a prediction network that predicts the confidence score for the connection. Different models may be used by confidence score predictor 1004 to determine the confidence score.

Conclusion

Accordingly, a verification process is improved using graph database 200. For example, using graph database 200 may improve the verification process by dynamically determining the number of references that are needed. The number of references that are needed may be eliminated or dynamically determined based on the information in graph database 200. The graph database is also improved by providing confidence scores for connections between the nodes. This is different from a graph database that may store just connections between nodes. The use of confidence scores may improve the verification process by quantifying a confidence score of the verification. Also, the use of graph database 200 may store the connections and allow the confidence score to be created quicker. For example, the confidence score for a candidate may be based on connections to other nodes and the connections in graph database 200 may be traversed faster to generate the confidence score.

System

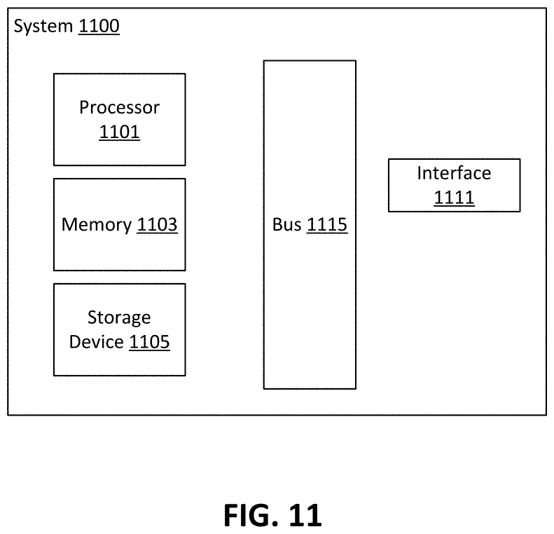

FIG. 11 illustrates an example of special purpose computer systems 1100 according to some embodiment. Computer system 1100 includes a bus 1102, network interface 1104, a computer processor 1106, a memory 1108, a storage device 1110, and a display 1112.

Bus 1102 may be a communication mechanism for communicating information. Computer processor 1106 may execute computer programs stored in memory 1108 or storage device 1108. Any suitable programming language can be used to implement the routines of some embodiments including C, C++, Java, assembly language, etc. Different programming techniques can be employed such as procedural or object oriented. The routines can execute on a single computer system 1100 or multiple computer systems 1100. Further, multiple computer processors 1106 may be used.

Memory 1108 may store instructions, such as source code or binary code, for performing the techniques described above. Memory 1108 may also be used for storing variables or other intermediate information during execution of instructions to be executed by processor 1106. Examples of memory 1108 include random access memory (RAM), read only memory (ROM), or both.

Storage device 1110 may also store instructions, such as source code or binary code, for performing the techniques described above. Storage device 1110 may additionally store data used and manipulated by computer processor 1106. For example, storage device 1110 may be a database that is accessed by computer system 1100. Other examples of storage device 1110 include random access memory (RAM), read only memory (ROM), a hard drive, a magnetic disk, an optical disk, a CD-ROM, a DVD, a flash memory, a USB memory card, or any other medium from which a computer can read.

Memory 1108 or storage device 1110 may be an example of a non-transitory computer-readable storage medium for use by or in connection with computer system 1100. The non-transitory computer-readable storage medium contains instructions for controlling a computer system 1100 to be configured to perform functions described by some embodiments. The instructions, when executed by one or more computer processors 1106, may be configured to perform that which is described in some embodiments.

Computer system 1100 includes a display 1112 for displaying information to a computer user. Display 1112 may display a user interface used by a user to interact with computer system 1100.

Computer system 1100 also includes a network interface 1104 to provide data communication connection over a network, such as a local area network (LAN) or wide area network (WAN). Wireless networks may also be used. In any such implementation, network interface 1104 sends and receives electrical, electromagnetic, or optical signals that carry digital data streams representing various types of information.

Computer system 1100 can send and receive information through network interface 1104 across a network 1114, which may be an Intranet or the Internet. Computer system 1100 may interact with other computer systems 1100 through network 1114. In some examples, client-server communications occur through network 1114. Also, implementations of some embodiments may be distributed across computer systems 1100 through network 1114.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving, by a computing device, a request for employment verification of a company for a user;
reviewing, by the computing device, a data structure for a node associated with the user;
determining, by the computing device, a number of references that are needed for the user for verification of the company based on reviewing the data structure;
receiving, by the computing device, information from the number of references for the verification of the company;
generating, by the computing device, a first connection between the node associated with the user and a node for the company, and a number of second connections between nodes for the number of references and the node associated with the user;
generating, by the computing device, a score for the verification based on scores for nodes that are determined based on the first connection and the number of second connections; and
determining, by the computing device, a decision on the verification of the company based on the score.

2. The method of claim 1, wherein determining the decision comprises:
verifying the user worked for the company based on the score meeting a threshold.

3. The method of claim 1, wherein determining the decision comprises:
indicating that the user is not verified as working at the company based on the score not meeting a threshold.

4. The method of claim 1, wherein determining the number of references that are needed comprises:
using the score for the user to dynamically determine the number of references.

5. The method of claim 4, wherein:
when the score is a first number, the number of references is fewer than when the score is a second number.

6. The method of claim 4, wherein using the score to dynamically determine the number of references comprises:
comparing the score to one or more thresholds; and
selecting the number of references based on the score meeting one of the one or more thresholds.

7. The method of claim 4, wherein:
a set number of references is used when the node for the user is not found in the data structure; and
a number fewer than the set number of references is used when the node for the user is found in the data structure.

8. The method of claim 1, wherein reviewing the data structure comprises:
determining whether the node associated with the user exists in the data structure; and
determining the score associated with node associated with the user exists in the data structure; and
using the score to determine the number of references.

9. The method of claim 8, further comprising:
using a score for another node to determine the number of references.

10. The method of claim 1, further comprising:
updating another score for another node based on generating the score for the node associated with the user.

11. The method of claim 10, wherein the another score is updated based on a connection to the node associated with the user.

12. The method of claim 10, wherein scores associated with nodes that are a number of layers away from the node associated with the user are updated.

13. The method of claim 1, further comprising:
creating a node in the data structure for a reference in the number of references;
connecting the node to the company; and
generating a score for the node based on connections to the node for the reference.

14. The method of claim 1, wherein:
a first score is associated with the first connection between the node for the user and the company, and
a second score is associated between a second connection between the node for the user and a node for a reference.

15. The method of claim 1, wherein the data structure includes:
first scores between nodes and the node for the company,
second scores for nodes between the user and the number of references, and
the score for the user is determined based on at least a portion of the first scores and the second scores.

2. A non-transitory computer-readable storage medium having stored thereon computer executable instructions, which when executed by a computing device, cause the computing device to be operable for:
receiving a request for employment verification of a company for a user;
reviewing a data structure for a node associated with the user;
determining a number of references that are needed for the user for verification of the company based on reviewing the data structure;
receiving information from the number of references for the verification of the company;
generating a first connection between the node associated with the user and a node for the company, and a number of second connections between nodes for the number of references and the node associated with the user;
generating a score for the verification based on scores for nodes that are determined based on the first connection and the number of second connections; and
determining a decision on the verification of the company based on the score.

17. The non-transitory computer-readable storage medium of claim 16, wherein determining the number of references that are needed comprises:
using the score for the user to dynamically determine the number of references.

18. The non-transitory computer-readable storage medium of claim 17, wherein:
when the score is a first number, the number of references is fewer than when the score is a second number.

19. The non-transitory computer-readable storage medium of claim 17, wherein using the score to dynamically determine the number of references comprises:
comparing the score to one or more thresholds; and
selecting the number of references based on the score meeting one of the one or more thresholds.

3. An apparatus comprising:
one or more computer processors; and
a computer-readable storage medium comprising instructions for controlling the one or more computer processors to be operable for:
receiving a request for verification of a company for a user;
reviewing a data structure for a node associated with the user;
determining a number of references that are needed for the user for employment verification of the company based on reviewing the data structure;
receiving information from the number of references for the verification of the company;
generating a first connection between the node associated with the user and a node for the company, and a number of second connections between nodes for the number of references and the node associated with the user;
generating a score for the verification based on scores for nodes that are determined based on the first connection and the number of second connections; and
determining a decision on the verification of the company based on the score.
